(19) United States
(12) Patent Application Publication
(10) Pub. No.: US 2003/0070524 A1
(43) Pub. Date: Apr. 17, 2003

(54) Cutting system for cutting profiles in air-permeable and resilient materials and method

(76) Inventors: Martin J. Rotter, Glenside, PA (US); William L. Chesterson, Richboro, PA (US); Michael J. Mosley, Princeton, NJ (US); John A. Greenwald, Burlington, NJ (US); Charles G. Bechtle, Bensalem, PA (US); James S. Patton, Newton, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/227,005

(22) Filed: Aug. 23, 2002

Related U.S. Application Data
(63) Continuation-in-part of application No. PCT/US01/07570, filed on Mar. 9, 2001.
(60) Provisional application No. 60/188,407, filed on Mar. 10, 2000.

(51) Int. Cl. B23D 53/00

(52) U.S. Cl. 83/781; 451/548

(57) ABSTRACT

A cutting system for cutting profiles in a strip of air-permeable material. The system includes a conveyor path to support the strip of material. A profile cutting tool mounted for movement toward and away from the conveyor path is provided to cut a desired profile across the strip. A hold down is located in proximity to the profile cutting tool to hold the strip of material in position during cutting. A controller is connected to the cutter for activating the cutter to cut the desired profile.

### BACKGROUND

The requirements for building ventilation in order to prevent damage to a roof structure are generally known. One system for ventilating a roof structure which was invented by the present inventor is a ridge vent utilizing a strip of air-permeable material over a slot which extends along the roof ridge. The air-permeable strip of material allows ventilation of the attic space under the roof by convection air flow as well as suction resulting from wind blowing across the roof, and at the same time prevents the ingress of moisture, debris and insects. A ridge cap is typically installed over the air-permeable strip in order to prevent direct ingress of moisture.

For roofs having contoured shapes, such as roofs having an outer surface formed by roofing panels which include a plurality of standing seams and/or stiffening ribs in a repeating pattern, it is known to use a ventilation strip having a surface which includes a plurality of recesses shaped to match the ribs or standing seams of the roof panel. This contoured strip includes an air-permeable and resilient portion or may be formed entirely from such material, in order to allow the desired ventilating airflow. A ridge cap is installed over the air-permeable portion. Such a system is described in U.S. Pat. No. 5,561,953, which was invented by the present inventor and is incorporated herein by reference as if fully set forth.

The preferred strip is an air-permeable and resilient material formed from nonwoven synthetic fiber matting, as described in the present inventor's prior U.S. Pat. No. 5,167,579, which is incorporated herein by reference as if fully set forth. While attempts have been made to manufacture such strips from the preferred material, it has not been possible to produce the required profiles in the strip economically or in a manner which allows commercial production of such materials. The material is difficult to handle due to its extremely flexible and porous nature, and the required complementary projections and recesses to match a roof profile must be matched with precision. This is further complicated by the multitudes of roofing profiles available, which requires a high tooling expenditure.

It would be desirable to provide a profiling system for accurately and repeatably cutting profiles in the air-permeable materials utilized for such ridge vents such that strips of air-permeable material having the desired profile to match a roof panel having a plurality of standing seams and/or stiffening ribs can be provided. It would also be desirable to reduce tooling costs and provide for the precision cutting of various shapes, including undercuts, in a manner that can be easily and quickly adapted to different profiles.

### SUMMARY

The present invention is generally directed to a cutting system for cutting profiles in an air-permeable strip of material, preferably for use in connection with ridge vents for contoured roofs. The cutting system comprises a conveyor path along which the strip of material for cutting is transported. A profile cutting assembly and a material strip holder are located along the conveyor path. A controller is connected to the profile cutting assembly to cut a desired profile in the strip of material as it is advanced along the conveyor path.

In one embodiment the cutting system includes a rotary cutter with a profile corresponding to a profile of a desired roof panel having a plurality of cutting surfaces or an abrasive coating. The cutter is mounted for movement transverse to the strip of material to be processed. A material moving system is provided for indexing the strip of material along the path, stopping the material at desired intervals such that the cutter can cut a profile across the strip in order to form the desired profile. Preferably, a clamp plate is provided for holding resilient material in order to ensure an accurate profile cut. A controller is provided for indexing the strip of material forward and driving the cutter.

In another aspect, the cutting system includes an endless cutting band mounted transversely to a direction of travel of the strip of material along the conveyor path. The cutting band is moved upwardly and downwardly in timed motion as the strip is advanced along the conveyor path in order to form a desired profile on the strip. Alternatively, the cutting band is mounted for X-Z movement in order to form a desired cut-out profile in the material strip. A controller is provided for controlling the movement of the cutting system and the strip of material. Multiple types of cutters can be used in the cutting system in accordance with the present invention in order to cut various profiles and shapes.

In another aspect, the present invention provides a calendaring system for providing a material strip with a consistent and uniform height to the cutting system. The calendaring system includes a heater to heat the material strip, a plurality of calendaring rolls which can be set to a desired spacing, and a blower to cool the material strip so that it is maintained at the desired height.

In another aspect, the present invention provides a stripper system to remove trapped waste material which remains in negative profiles. The stripper system includes a curved portion of material path which causes the material strip to flex open at the profile cut-out locations, and at least one brush to dislodge the trapped waste material. Alternatively, a picker may be provided to grip the trapped waste and pull it from the material strip.

In another aspect of the invention, an improved wind-up station for bundling the profiled vent material is provided. The wind-up station includes a driven spool having a rotatable clamp to clamp the material in a central location prior to winding the profiled material into a roll. A stapler assembly is located adjacent to the spool, and is adapted to drive a barbed plastic tie through the free ends of the material to hold each bundle together.

In another aspect, the invention provides a flexible cutter assembly that includes a universal shaft upon which a plurality of desired cutters can be arranged. Cutters having different profiles can be provided and located at any desired position, preferably using a positioning template, and are locked in place on the universal shaft. The cutter assembly is then mounted in the profile cutting shuttle.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements shown.

FIG. 1 is a side-elevational view of a cutting system in accordance with the present invention for cutting profiles in a strip of air-permeable material.

FIG. 2 is a top-plan view of the cutting system of FIG. 1, taken along lines 2-2 in FIG. 1.

FIG. 3 is a perspective view of the cutting assembly in accordance with a first preferred embodiment of the invention.

FIG. 4 is a side-elevational view of the cutting assembly taken along lines 4-4 in FIG. 3.

FIG. 5 is a side-elevational view of the cutting assembly taken along lines 5-5 in FIG. 4.

FIG. 6 is a top-plan view of the cutting assembly taken along lines 6-6 in FIG. 4.

FIG. 7 is a top plan view of one preferred cutter utilized in the first embodiment of the cutting assembly shown in FIG. 3.

FIG. 8 is a top plan view of a preferred hold down plate utilized in connection with the cutter shown in FIG. 7 for the first embodiment of the cutting assembly.

FIG. 9 is a perspective view, partially broken away, of a second embodiment of a cutting assembly in accordance with the present invention.

FIG. 10 is a perspective view, partially broken away, of a third embodiment of a cutting assembly in accordance with the present invention.

FIG. 11 is a side elevational view of two calendar wheels used in conjunction with the cutting system in accordance with the first embodiment of the present invention.

FIG. 12 is a perspective view, partially broken away, of a baffle cutting and filling arrangement used in an alternate embodiment of the cutting system in accordance with the present invention.

FIG. 13 is a cross-sectional view of the air permeable strip with the filled baffle taken along lines 13-13 in FIG. 12.

FIGS. 14A, 14B and 14C are a side elevational view of a second embodiment of a cutting system in accordance with the present invention for cutting profiles in a strip of air-permeable material.

FIG. 15 is a top view of a height adjustable feed roller assembly taken along lines 15-15 in FIG. 14A.

FIG. 16 is a perspective view of a cut-off saw used to cut the strips of material to a predetermined length.

FIG. 17 is a perspective view of a profile cutting assembly for cutting positive profiles used in the second embodiment of the cutting system shown in FIGS. 14A-14C.

FIG. 18 is a perspective view of an undercut profile cutting assembly used in the second embodiment of the cutting system shown in FIGS. 14A-14C.

FIG. 19 is an elevational view of a glue dispenser taken along lines 19-19 in FIG. 14C.

FIG. 20 is a perspective view of a picker assembly used to pick trapped material from the undercut profiles.

FIG. 21 is a perspective view of the picker head in FIG. 20.

FIG. 22 is a perspective view of an alternate embodiment of the profile cutting and glue applicator assemblies.

FIG. 23 is a perspective view of the alternate embodiment of the hold down assembly used with the profile cutting assembly of FIG. 22.

FIG. 24 is is a side elevational view of an alternate embodiment of the cutter assembly, preferably used in connection with profile cutting assembly shown in FIG. 22, with removable cutter rings mounted on a universal shaft.

FIG. 25 is an end view of the cutter assembly in FIG. 24.

FIG. 26 is a perspective view of a slitter and take-up assembly, preferably used in conjunction with the profile cutting and glue applicator assemblies shown in FIG. 22.

FIG. 27 is side elevational view of the slitter and take-up assembly shown in FIG. 26.

FIG. 28 is a perspective view showing the drive components for the take-up spool assembly in FIG. 26.

FIG. 29 is a cross-sectional view taken along line 29-29 shown in FIG. 28 of the spool assembly prior to clamping on an inserted piece of profiled material.

FIG. 30 is a cross-sectional view similar to FIG. 29 showing the spool assembly in the clamped position.

FIG. 31 is a side elevational view of a stapler assembly used to hold rolls of profiled material together.

FIG. 32 is a view of the plastic attachment element used by the stapler assembly of FIG. 31.

FIG. 33 is a top view taken along line 33-33 in FIG. 31.

### DETAILED DESCRIPTION OF THE PREFERRED EMBODIMENTS

Certain terminology is used in the following description for convenience only and is not considered limiting. The words “right”, “left”, “lower” and “upper” designate directions in the drawings to which reference is made. This terminology includes the words specifically noted above, derivatives thereof and words of similar import. Additionally, the terms “a” and “one” are defined as including one or more the referenced item unless specifically noted.

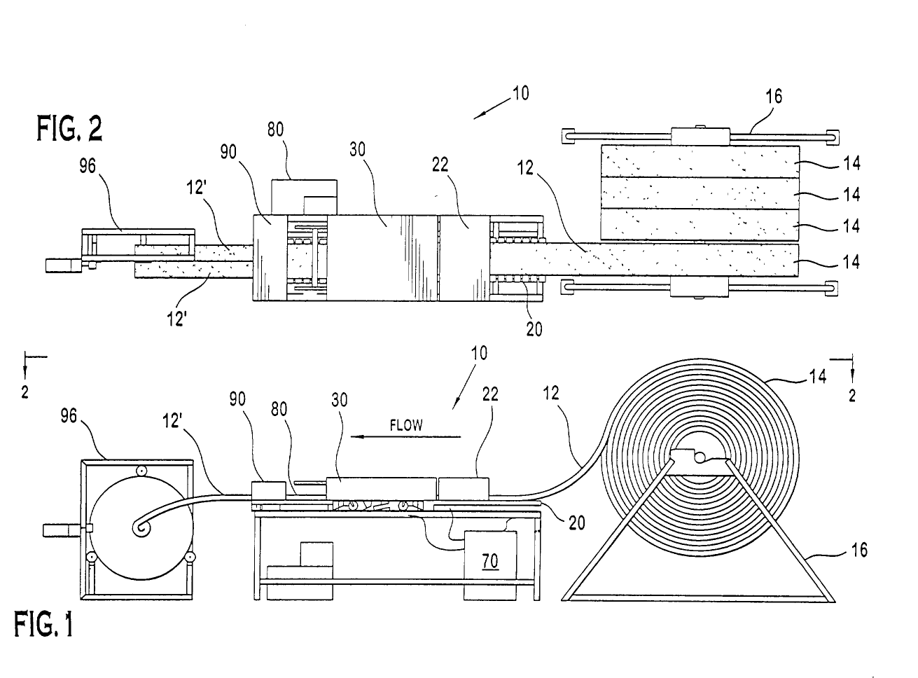

Referring now to FIGS. 1 and 2, a first embodiment of a cutting system 10 for cutting profiles in a strip of material 12 is shown. Preferably, the material 12 is provided in roll form and comprises a strip of non-woven synthetic fiber matting as described in the inventor's prior U.S. Pat. No. 5,167,579. However, it will be recognized by those skilled in the art from the present disclosure that the cutting system 10 may be used in connection with other strips of materials which must be profiled, such as rubber, plastic, foam or other types of material. The strips of material 12 are provided to the cutting system 10 in bulk rolls 14 which are preferably mounted on an unreeling stand 16. Direct feed from a webber or other production equipment for the material 12 is also possible. The material 12 is moved along a conveyor path 20 of the cutting system 10 for processing. The conveyor path 20 may be in the form of rollers, a moving belt or simply a support surface along which the strip of material 12 is moved. If rollers or a moving belt are utilized as the conveyor path 20, they form part of a strip positioning system and are preferably driven by a servo motor or other controllable motor such that the speed of the strip of material 12 being carried through the cutting system 10 is controllable. Alternatively, if the strip of material 12 slides along a surface, it may be moved by a strip positioning system comprised of driving wheels which engage the strip that are connected to a servo motor or other controllable means for advancing the material which are capable of controlling the speed at which the strip of material 12 moves along the conveyor path 20. Depending upon the drive system utilized for moving the strip of material 12 along the conveyor path 20, a tachometer or other speed sensor may be provided in order to detect the actual speed or displacement of the material along the conveyor path 20. Alternatively, the speed can be determined by a feedback signal from the motor or a position sensor located thereon.

Still with reference to FIGS. 1 and 2, preferably the material 12 first passes through a cut-off saw 22 mounted along the conveyor path 20. The cut-off saw 22 is used to cut strips of the material 12 to a desired length. The cut-off saw 22 preferably includes a rotary blade or abrasive wheel which is moved in a direction transverse to the direction of movement of the strip of material 12 along the conveyor path 20 in order to cut strips of material 12 to the desired length by cutting through or nearly through the material strip 12. It is preferred that approximately 1/8 of an inch of material is left uncut along the bottom of the strip 12 to hold the strips together as they pass through the cutting system 10, but can be easily separated for packaging after processing. While a rotary saw is preferred for the cut-off saw 22, it will be recognized by those skilled in the art that other types of cutting implements can be used, such as a hot-wire, a band saw, a shear, or any other type of cut-off device, depending upon the characteristics of the material 12. In one preferred embodiment, strips of material 12 are cut to lengths of 50 feet. Alternatively, as described below, the cut-off saw 22 could be located further along the conveyor path 20.

As the material 12 progresses along the conveyor path 20, it passes into a profile cutting assembly 30 in accordance with a first preferred embodiment of the invention. The profile cutting assembly 30 cuts a profiled shape across the width of the strip of material 12, transverse to the direction of travel of the material 12 along the conveyor path 20.

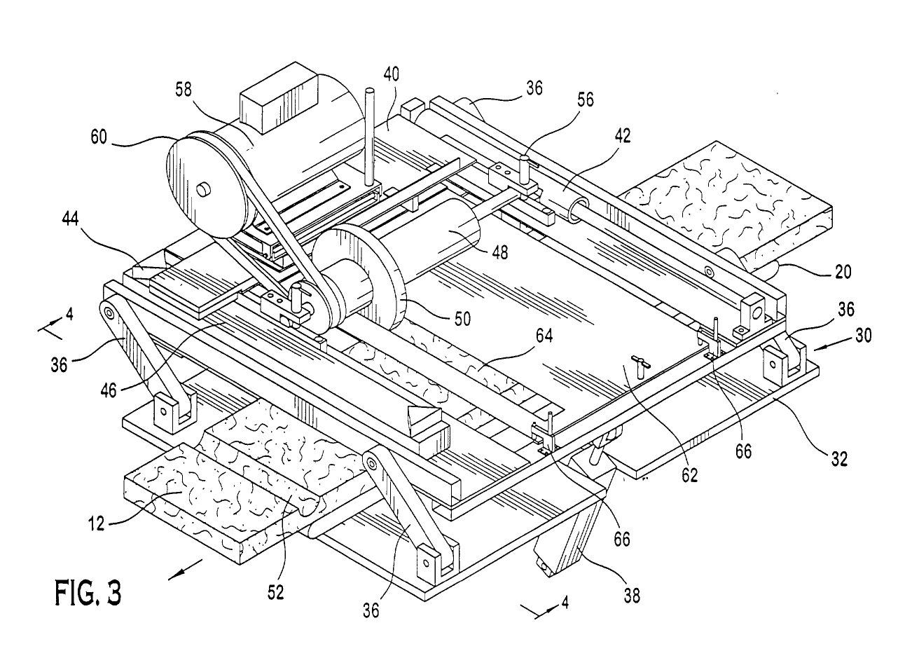

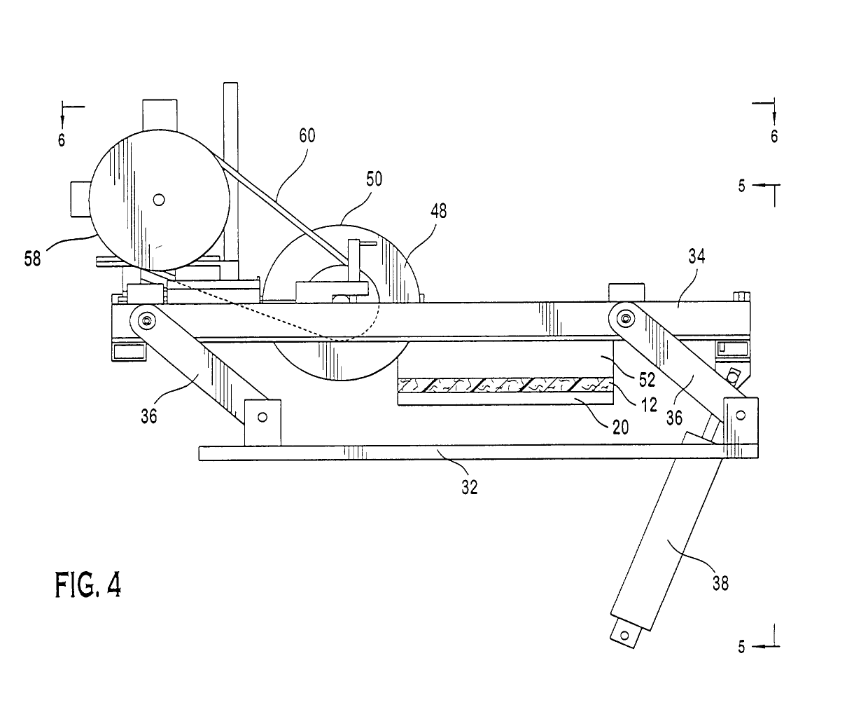

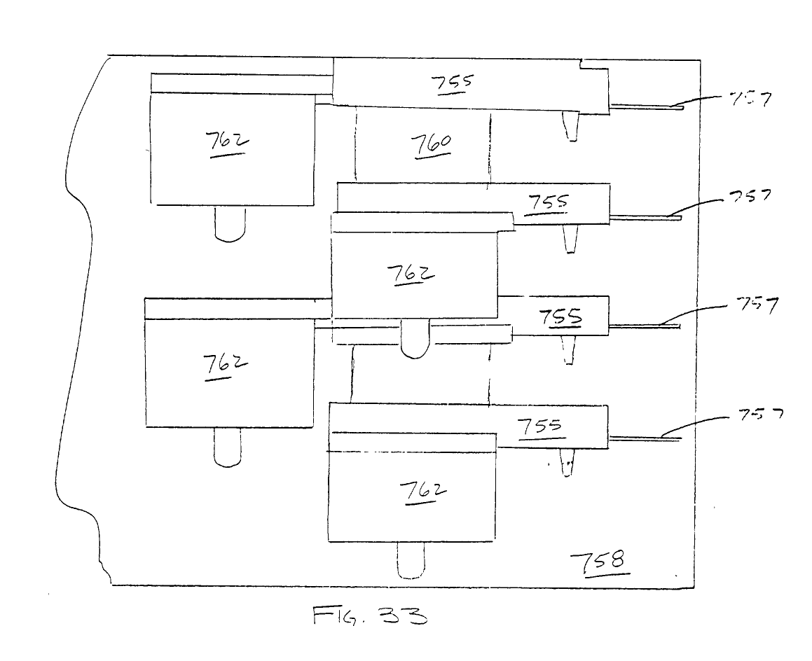

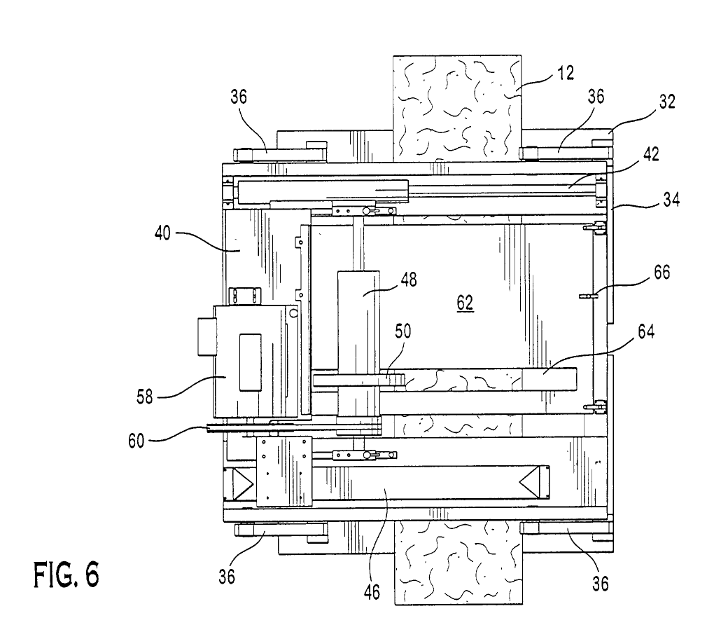

Referring now to FIGS. 3-6, the first preferred embodiment of the profile cutting assembly 30 is shown in detail. As shown in FIG. 3, preferably the profile cutting assembly 30 includes a fixed support 32 and a moveable support 34. The fixed support 32 is mounted along the conveyor path 20. The moveable support 34 is mounted for up and down movement relative to the fixed support 32. In the preferred embodiment, the moveable support 34 is connected by pairs of parallel links 36 to the fixed support 32. An actuator or lift cylinder 38 is connected to the moveable support 34 to move the moveable support 34 up and down relative to the conveyor path 20. Alternatively, multiple linear actuators may be used for direct up and down movement in place of the parallel links 36.

A profile cutting shuttle 40 is mounted on the moveable support 34 via a linear guide arrangement 42. The profile cutting shuttle 40 is moved via an actuator 44, preferably in the form of a rodless cylinder 46, back and forth on the moveable support 34 in a direction transverse to the conveyor path 20. A profile cutting wheel 48 is mounted for rotary movement on the profile cutting shuttle 40. The profile cutting wheel 48 is preferably a shaped mandrel having a profile which matches a repeat profile of a contoured roofing panel. For example, the illustrated wheel 48 includes a single rib cutting profile 50 which could be used to cut a rib profile 52 in the strip of material 12 at desired intervals in order to match a corresponding roof panel. The profile cutting wheel 48 is removably mounted on the profile cutting shuttle 40 via a clamping arrangement 56 in order to allow the profile cutting wheel 48 to be quickly and easily replaced with cutting wheels having different profiles for different roof panels. In the preferred embodiment, the profile cutting wheel 48 is coated with an abrasive grit which has been found to be very effective in cutting the non-woven synthetic fiber matting used in conjunction with the preferred embodiment. However, the profile cutting wheel 48 may be formed with other types of cutting means, such as profiled teeth, which may be made of carbide or tool steel, or other types of rotary cutting tools, if desired.

A motor 58 for driving the profile cutting wheel 48 is also located on the profile cutting shuttle 40. The profile cutting wheel 48 is driven via a belt 60 connected to the motor 58. A hold-down plate 62 is also mounted on the moveable support 34 to hold the strip of material 12 firmly in position as the profile is being cut. This allows the profile to be accurately cut in the material 12. The pressure plate 62 includes a slot or plurality of slots 64 to match the rib cutting profile 50 of the profile cutting wheel 48.

At each position corresponding to a rib location on a contoured roofing panel, a rib profile 52 is cut in the strip of material 12 by utilizing the lift cylinder 38 to lower the moveable support 34 such that the pressure plate 62 contacts the surface of the strip of material 12 to hold it firmly in position. The motor 58 drives the profile cutting wheel 48 as the profile cutting shuttle 40 is moved in at least one direction by the rodless cylinder 46 to cut the rib profile 52 in the strip of material 12. The lift cylinder 38 is then actuated to move the moveable support 34 upwardly such that the profile cutting wheel 48 and pressure plate 62 are no longer in contact with the strip of material 12. This process is repeated as the strip of material 12 is indexed forward along the conveyor path 20.

Preferably, the pressure plate 62 is held in position via easily removable clamps 66 which may be located in all four corners, such that the pressure plate 62 for a given profile cutting wheel 48 can be easily and quickly changed along with the cutting wheel 48 for different profiles of roofing panels.

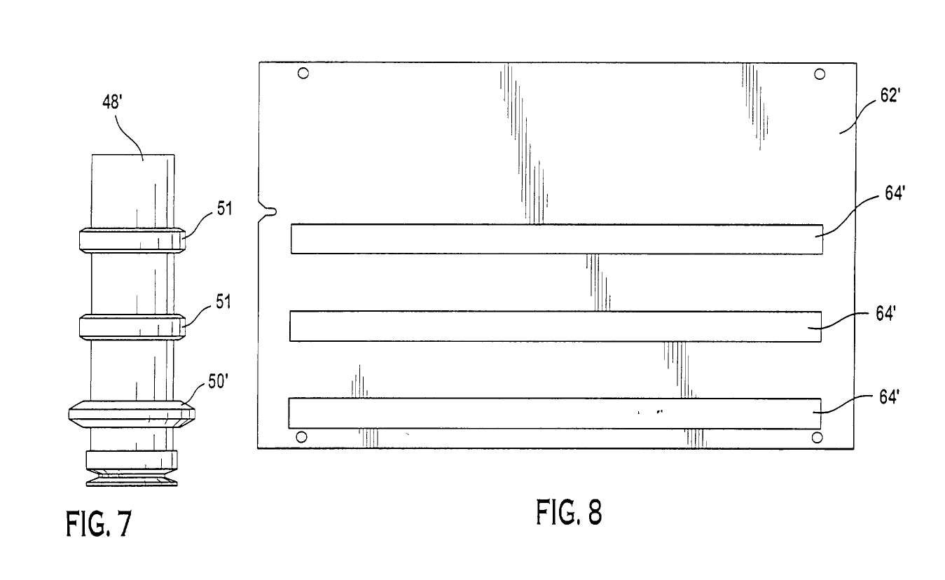

Referring now to FIG. 7, another embodiment of a profile cutting wheel 48′ is shown. The profile cutting wheel 48′ includes a large diameter rib cutting profile 50′ and two smaller rib cutting profiles 51. The profile cutting wheel 48′ may be made of aluminum and the rib cutting profiles 50′, 51 may be coated with an abrasive grit or may be formed from or coated with a hardened material to extend the life of the cutter. Those skilled in the art will recognize from the present disclosure that different profile cutting wheels 48, 48′ will be required depending upon the spacing and size of the standing seams and/or ribs on a given roof panel. These different profile cutting wheels can be easily installed on the profile cutting shuttle 40 using the clamping arrangement 56.

Referring now to FIG. 8, a hold-down plate 62′ having slots 64′ which correspond to the profile of the profile cutting wheel 48′ is shown. Preferably, each different profile cutting wheel 48, 48′ will have a corresponding hold-down plate 62, 62′ which is mounted to the profile cutting shuttle 40. The hold-down plates 62, 62′ preferably include holes in proximity to the comers for clamping to the shuttle 40 via the clamps 66. One or more indexing notches may also be provided to maintain proper alignment of the hold-down plate 62, 62′.

The profile cutting wheels 48, 48′ have proven extremely effective in cutting positive profiles in the material strip 12. Positive profiles refer to any profile which can be cut by a rotary action. However, this type of cutting wheel 48 cannot be used to cut negative profiles, such as a J-shape or any other shape in which the entry cut has a smaller dimension than an internal feature of the profile shape.

As shown in FIG. 1, preferably the cut-off saw 22 and the profile cutting assembly 30, including both the actuator 38 and the rodless cylinder 46, are connected to a programmable controller 70, which actuates the cut-off saw 22 and the profile cutting assembly 30 at the required spacing along the strip of material 12 in order to produce strips of a desired length and having the desired profile based upon the profile of the cutting wheel 48 being cut into the strip of material 12 at the desired intervals.

Referring again to FIGS. 1 and 2, preferably a glue station 80 is provided downstream of the profile cutting assembly 30 which applies glue to a face of the strip of material 12. The glue may be applied continuously, but is preferably only provided at predetermined intervals, or in the profiled areas 52 of the strip 12. The glue station may be a Nordson model 3500V glue applicator. The glue is preferably heat activatable at elevated temperatures and may be used for securing the profiled strip of material 12 in position along a contoured roof panel. However, the glue station can be omitted, if desired.

A slitting saw 90 is preferably located downstream of the glue applicator 80 and is used to slit the strip of material 12 into a plurality of narrower strips. The slitting saw preferably includes one or more abrasive wheels or rotary blades which are spaced apart at a desired width. Depending upon the width of the strip of material 12 desired, multiple slitting saws may be provided or the slitting saws may be omitted. Other slitters may be utilized, such as a hot-wire, a laser, reciprocating blade or any other suitable slitting mechanism for the material 12 being utilized. The profiled and slit strips of material, referenced as 12′ in FIGS. 1 and 2, are preferably wound onto rolls via a winder located in a take-up station 96. Preferably, the take-up station 96 can wind several strips of material 12′ at the same time for either automatic or manual packaging. Alternatively, the strips 12′ may be folded for packaging. While automated take-up means are preferred, it is also within the scope of the present invention to have the strips 12′ manually packaged.

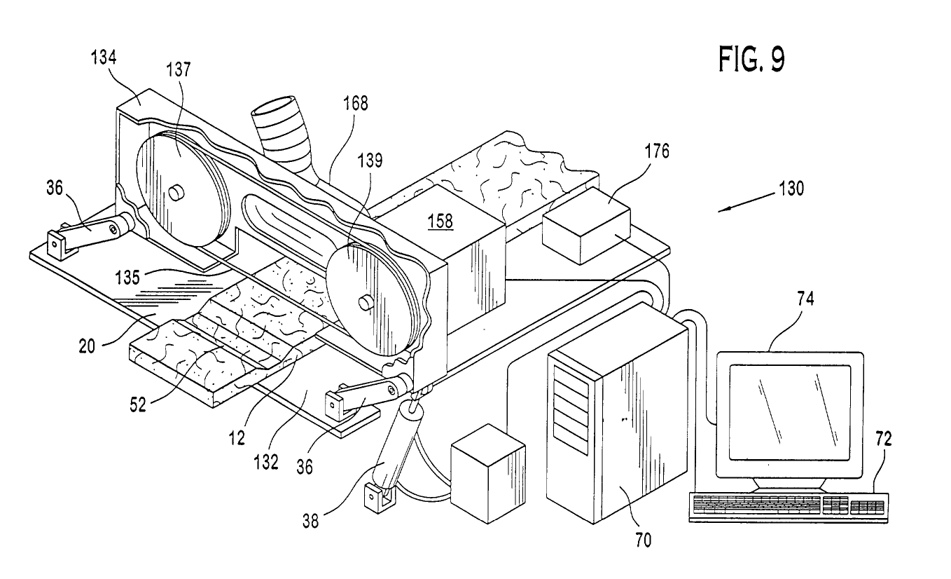

Referring now to FIG. 9, a second embodiment of the profile cutting assembly 130 is provided. The profile cutting assembly 130 includes the fixed support 132 with a moveable support 134 connected to the fixed support 132 via parallel links 36. The actuator 38 is utilized to move the moveable support 134 up and down relative to the fixed support 132 over the strip of material 12 on the conveyor path 20. An endless cutting band 135 is located in a housing on the moveable support 134, and is preferably supported via wheels 137, 139 located on opposite sides of the support 134. At least one of the wheels 137, 139 is driven via a motor 158 in order to move the endless cutting band 135. The endless cutting band 135 may be a toothed blade or a grit-impregnated or coated strand of material which is moved via the wheels 137, 139 in order to cut a rib profile 52 in the strip of material 12. Preferably, the actuator 38 is connected to the controller 70 in order to move the endless cutting band 135 up and down relative to the strip of material 12 as the strip of material 12 is moved forward along the conveyor path 20. By timed movement of the moveable support 134 with the endless cutting band 135 up and down in conjunction with the movement of the strip of material 12, the rib profile 52 is formed. Preferably, the controller 70 is connected to the actuator 38 as well as the motor 158. Input may also be provided from a tachometer 176 which senses the velocity of the strip of material 12 as it moves along the conveyor path 20. A keyboard 72 or other input device is preferably provided for communication with the controller 70. A monitor 74 may also be provided for the user interface with the controller 70.

Alternatively, a second actuator can be used to move the profile cutting assembly 130 and the endless cutting band 135 back and forth in the direction of travel of the strip 12. This movement can be used in conjunction with the up and down movement to form a desired profile in the strip 12.

As shown in FIG. 9, preferably a cutting dust and debris vacuum collection system 168 is connected to the housing located on the moveable support 134 in order to remove the cut material and dust formed during the cutting operation.

The profile cutting assembly 130 in accordance with the second preferred embodiment of the invention allows various different profiles to be cut without the need for changing the cutting band 135. Separate hold-down means may be provided for holding the strip of material in place as the rib profile 52 is being cut. This could be in the form of rollers which would apply downward pressure on the material while still allowing movement of the strip of material 12 so that the desired rib profile 52 can be formed at the desired spacing. The strip of material 12 may also be passed between calendar rolls, as described in more detail below, in order to stabilize the strip of material 12 prior to cutting.

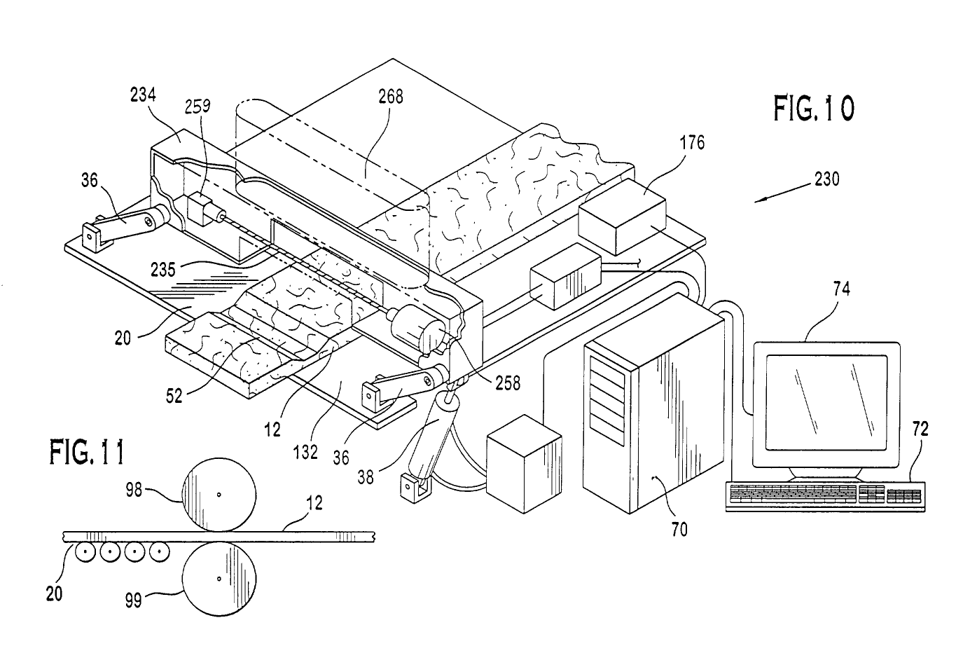

Referring now to FIG. 10, a third embodiment of the profile cutting assembly 230 is shown. The third embodiment of the profile cutting assembly 230 is similar to the second embodiment of the profile cutting assembly 130 and similar elements have been identified with the same reference numerals. The differences between the second and third embodiments of the profile cutting assembly will be described below.

In the third preferred embodiment of the profile cutting assembly 230, a rotary cutting shaft 235 is mounted in the moveable support 234. The cutting shaft 235 may be an abrasive coated or impregnated shaft or may have machined cutting flutes for cutting the rib profiles 52 into strip of material 12. Preferably, the cutting tool 235 is connected to a high speed motor 258 which rotates the cutting tool 235 at high speeds (preferably in range of 10,000-25,000 rpm) in order to cut the rib profiles 52. A tail stock 259 is provided for receiving the non-driven end of the cutting tool 235. The moveable support 234 is moved up and down in order to move the cutting shaft 235 up and down in synchronized movement with the strip of material 12 as it is advanced along the conveyor path 20 in order to form the desired rib profiles 52 on the strip of material 12. Alternatively, a second actuator can also be utilized to move the profile cutting assembly 230 back and forth in the direction of travel of the strip 12. This movement in conjunction with the up and down movement can be used to form a desired profile in the strip 12. A dust hood 268 is connected to a vacuum system to remove debris.

Referring now to FIG. 11, at least one heated calendar roll 98, and preferably two calendar rolls 98, 99 may be provide on the upstream side of the profile cutting assembly 30, 130, 230. The calendar rolls 98, 99 are located on axes which extend transverse to the direction of travel of the strip of material 12 along the conveyor path 20 and stabilize the preferred non-woven matting strip of material 12 in order to achieve more accurate cutting of the desired rib profiles 52. While one calendar roll 98 can be provided to stabilize the upper surface of the strip of material 12 which is being cut, it is preferred that two calendar rolls 98, 99 be utilized. The calendar rolls 98, 99 may be heated to a temperature below the melting point of the non-woven matting to heat-set the material 12. Those skilled in the art will recognize that the calendar rolls 98, 99 may be omitted, if desired, when the pressure plate 62 is utilized, or depending upon the particular material used for the strip of material 12.

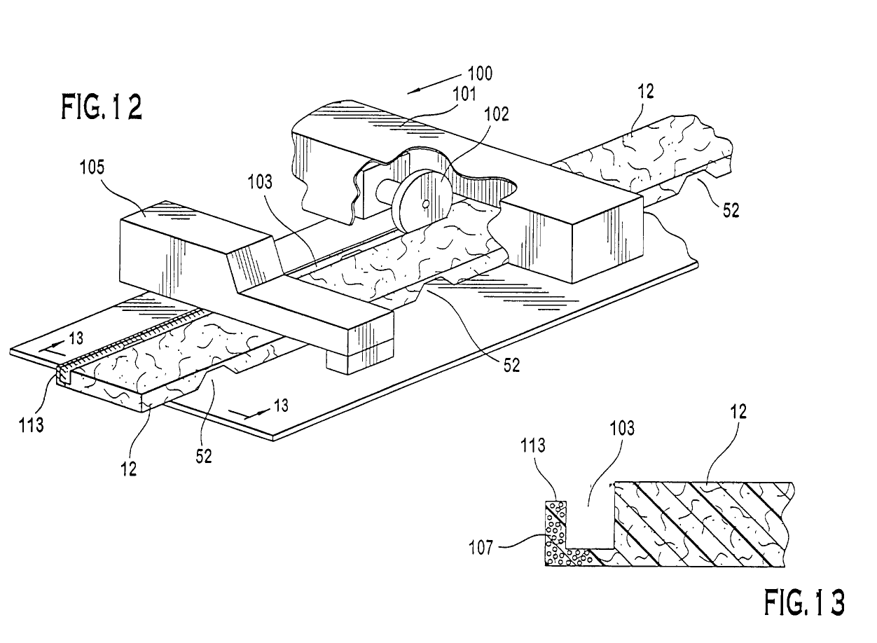

Referring now to FIG. 12, a baffle cutting and filling station 100 for an alternate embodiment of the cutting system 10 is shown. The preferred profiled strip of material 12 may be subject to water infiltration, and accordingly, it would be desirable to provide a baffle 113, as shown in FIG. 13, to prevent moisture ingress when the profiled strip 12 is installed as a roof vent. The baffle cutting and filling station 100 may be located either upstream or downstream of the profile cutting assembly 30, but is preferably located downstream. The profiled strip of material 12 is preferably inverted prior to entering the baffle cutting and filling station 100. Alternatively, the baffle cutting and filling equipment 100 can be arranged to cut the bottom side of the strip 12 and fill the baffle 113 from the side.

The baffle cutting and filling station 100 includes a cutting assembly 101 with a rotary cutter 102 for creating a slot 103 spaced inwardly from the side of the strip 12 to create the baffle 113. Preferably, the slot 103 is cut on the opposite side of the strip 12 from the rib profiles 52. However, the slot 103 may be cut on the same side, depending upon the particular application. Multiple rotary cutters 102 may be provided for cutting slots at desired locations on the strip 12 if the strip 12 is to be slit by the slitting saw 90. The rotary cutter 102 is connected to a motor for rotating the cutter 102. Preferably, the cutter 102 is an abrasive wheel. However, those skilled in the art will recognize from the present disclosure that other types of cutters, such as a diamond impregnated cutter, carbide cutter, steel cutter or masonry could be utilized, if desired.

As shown in FIG. 13, the height of the baffle 113 may also be cut shorter than the height of the strip 12 as the slot 103 is being cut. This may be accomplished by providing a stepped rotary cutter 102 which forms the slot 103 and trims the height of the baffle 113 at the same time. However, the baffle 113 may also be the same height as the strip 12, if desired.

The profiled strip of material 12 then passes into an injection filler 105 which injects a resin or adhesive 107 into the air permeable material of the baffle 113. The injected material 107 is preferably a polymeric material, and may be polyurethane or any other suitable resin which can be injected and rapidly cured, such as by UV radiation, or may be a hot melt type material, which may be injected hot into the baffle portion 113 of the air permeable strip 12 and cooled. The injection filler 105 is adapted to the specific material being used as a filler, and may be connected to an extruder barrel to provide heated material, or to one or more different supplies of adhesive components or resins for adhesive or reaction-injected molded type materials.

The strip 12 with the baffle 113 may be installed with the baffle 113 along the top edge of the strip 12 or with the baffle 113 on the bottom edge. The filled baffle 113 acts to prevent water from migrating through the strip of material 12, which could result in damage to the roof structure.

Referring now to FIGS. 14A-14C, a second embodiment of the cutting system 310 for cutting profiles in a strip of material 12 is shown. The second cutting system 310 is similar to the first cutting system 10, and is preferably used for cutting both positive and negative profiles in the strip of material 12, as described above.

As shown in FIG. 14A, preferably, an unwind station 316 is provided. The unwind station 316 includes a stand 317 with a live axle 318 upon which bulk rolls 14 of material 12 are loaded. The material strip 12 passes between a drive roll 319 and an idler roll 320. Preferably, the drive roll 319 is driven via a variable speed motor 322. In order to accommodate the stopping and starting movement of the strip 12 as it is fed through the profiling system 310, preferably a loop of the material 12 is formed between the various stations. The size of the loop is controlled by either increasing or decreasing the speed of the motor 322. The size of the loop is sensed via a dancer bar 324 which is free to move up and down depending upon the size of the loop of material 12 which presses down upon the bar 324. Alternatively, an photoeye which senses the loop can be utilized. Preferably, the motor 322 runs at a nominal speed and may be accelerated or decelerated to a higher or lower speed in order to maintain some excess material 12 for feeding into the remaining portions of the cutting system 310.

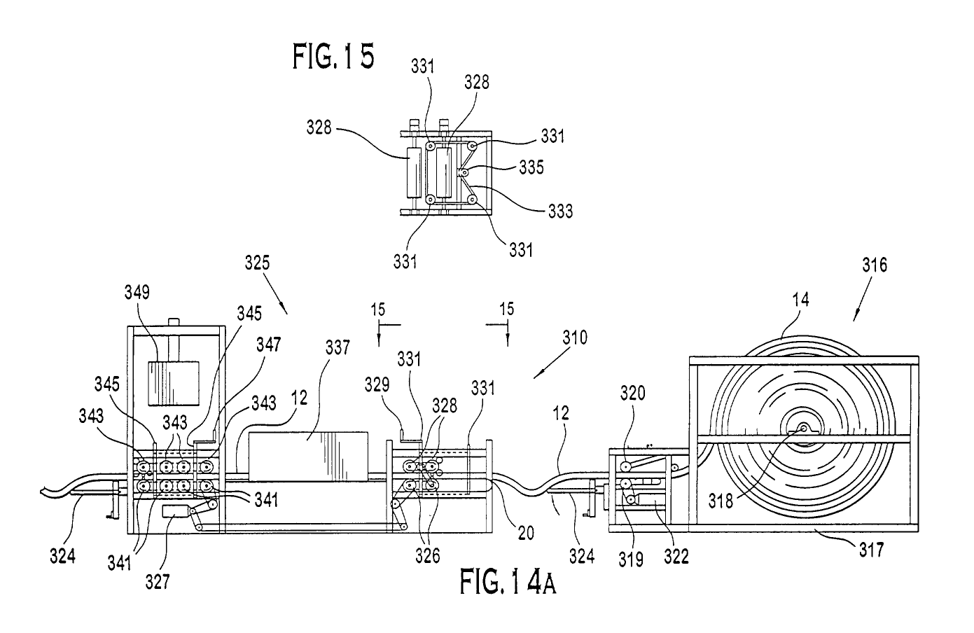

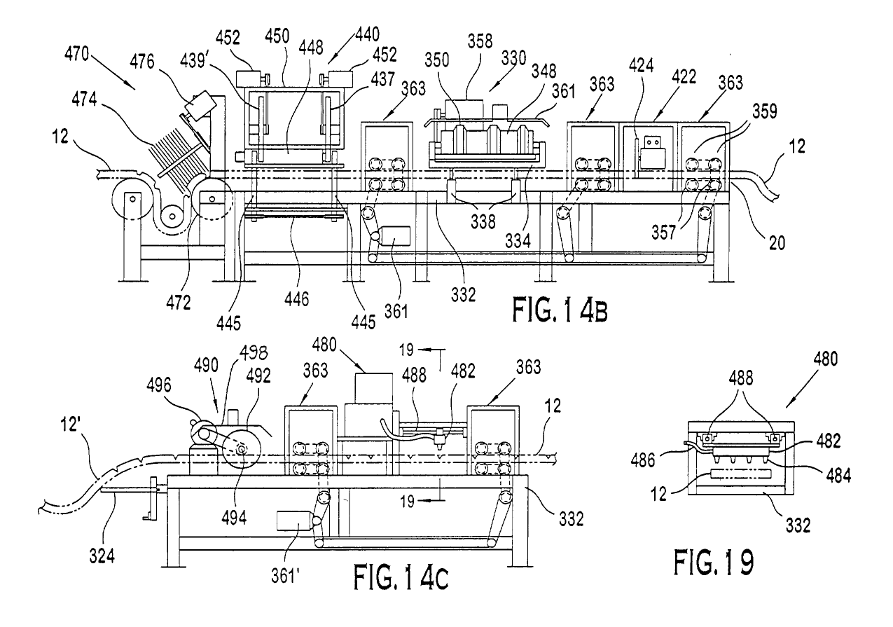

Still with reference to FIG. 14A, a calendering system 325 is shown. While calendering rolls 98, 99, as shown in connection with the first embodiment of the cutting system 10 may be effective for certain materials, depending upon the material, such as a synthetic non-woven fiber matting as described in the inventor's prior U.S. Pat. No. 5,167,579, it has been found that a more effective calendering means is required. The calendaring system 325 includes input rollers 326 for drawing material 12 into the calendering system 325. The input rollers 326 are driven via a drive motor 327 through a series of tooth belts and pulleys. Preferably, rollers 328 are provided over the strip of material 12. The upper rollers 328 are preferably mounted for movement up and down in order to provide a desired spacing between the rollers 326, 328. The rollers 328 may also be driven via toothed drive belts. Preferably, the upper rollers 328 are mounted in a height-adjustable frame which can be moved upwardly or downwardly via a crank handle 329 which is connected to four jack screws 331, as shown in detail in FIG. 15. The screws 331 are connected via a toothed belt or chain 333 such that turning the crank handle 329 advances all four jack screws 331 equally in order to move the upper rollers 328 to a desired height while maintaining the upper rollers 328 parallel to the lower rollers 326. An idler pulley or sprocket 335 may also be provided in order to provide proper tensioning in the toothed belt or chain 333.

The material 12 is then advanced through a heat tunnel 337 which heats the material to approximately 300° F. The heated material strip 12 is then passed through pairs of calendering rolls 341, 343. Preferably, the lower calendaring rolls 341 are driven via the same motor 327 as described above. The upper calendaring rolls 343 are preferably also driven. While the upper rolls 343 are shown above the material strip 12 for the sake of clarity in FIG. 14A, it will be understood by those skilled in the art that the calendaring rolls 343 would be in contact with the upper surface of the material strip 12 in order to press the material strip 12 to a desired height. Preferably, the upper calendaring rolls 343 are mounted on a height adjustable frame in a similar manner to the rolls 328. The upper frame is mounted on four jack screws 345 which can be turned via crank handle 347 in order to move the upper calendaring rolls 343 upwardly or downwardly to a desired height relative to the lower calendering rolls 341. Preferably, the jack screws 345 are arranged in a similar manner to the jack screws 331, as described above, and are connected together via a toothed belt or chain such that turning the crank handle 347 results in all four jack screws 345 rotating simultaneously such that the upper rollers are moved upwardly or downwardly in a parallel manner.

A blower 349 is mounted above the calendaring rolls 341, 343 in order to cool the strip of material 12 such that it sets at a desired thickness, which can be closely controlled. Preferably the blower provides approximately 2000 cubic feet per minute of air through the strip of material 12 for cooling. A second dancer bar assembly 324, similar to that described above, is located downstream of the calendering rolls 341, 343 in order to sense the size of the loop of material 12 which is formed after the calendaring system 325. This is used to control the speed of the motor 327 for advancing material through the calendering system 325.

The calendering system 325 may be omitted, if desired, depending upon the thickness tolerance of the material 12 provided to the cutting system 310.

Referring now to FIG. 14B, a plurality of drive stations 363 are provided along the conveyor path. Each drive station 363 includes at least one set of drive rollers 357, 359. The lower drive rollers 357 are preferably driven via a motor 361 through a system of toothed belts or chains. The upper rollers 359 are preferably also driven, but may be idler rolls, depending upon the particular application. The upper rollers 359 are preferably mounted in a height adjustable manner in order to accommodate different thicknesses of the material 12 being processed. The height adjustment may be via jack screws, such as jack screws 331 described above, or other means. While the upper rollers 359 have been shown spaced above the material strip 12 for the sake of clarity, it will be recognized by those in the art from the present disclosure that the rollers 359 would be set to the proper height to contact the upper surface of the material 12. Preferably, drive stations 363 are located between processing equipment in the cutting system 310 and maybe driven by the same motor 361 or a plurality of motors 361, 361′, as shown in FIG. 14C in order to advance the material strip 12 through the cutting system 310 in a controlled manner.

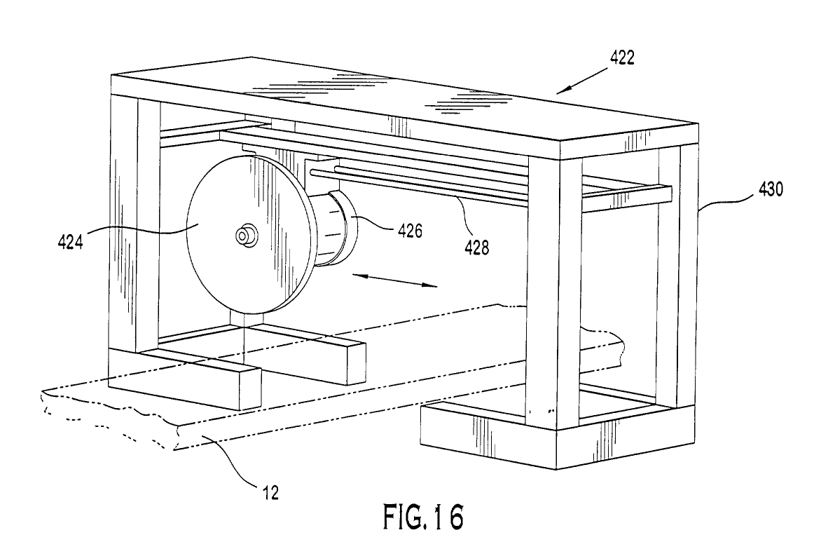

Still with reference to FIG. 14B, a cut off saw 422 is shown. The cut off saw 422 is similar to the cut off saw 22, and includes an abrasive wheel 424 in order to cut the strip of material 12 to desired lengths. As shown in FIG. 16, the abrasive wheel 424 is connected to a motor 426. A linear actuator 428 is used to move the motor 426 and abrasive wheel 424 back and forth across the strip of material 12 in order to cut the strip to a desired length. The linear actuator 428 is preferably mounted in a rigid frame 430 located along the path 20 of the material strip 12.

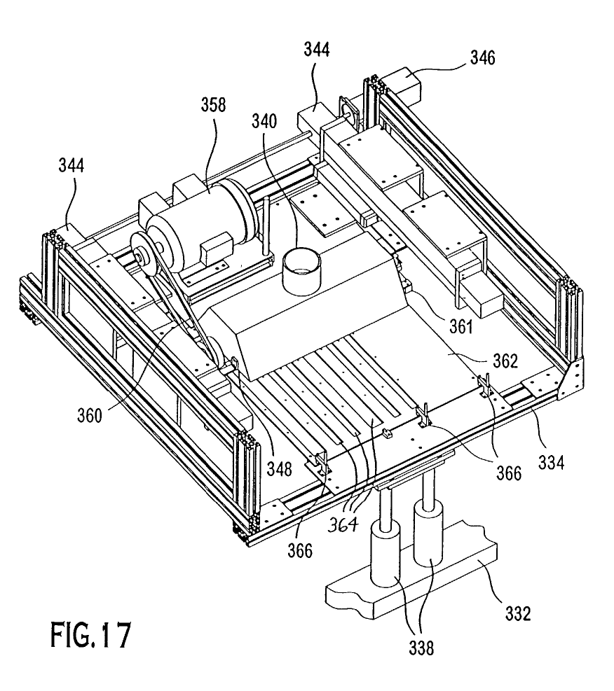

Referring again to FIG. 14B, the material 12 then passes into a profile cutting assembly 330, similar to that described above in connection with the first embodiment of the cutting system 10. The profile cutting assembly 330 includes a moveable support 334 which is mounted to the fixed frame 332 by four linear actuators or lift cylinders 338. The lift cylinders 338 move the moveable support 334 up and down. A profile cutting shuttle 340, shown in detail in FIG. 17, is mounted to the moveable support via linear actuators 344. The linear actuators 344 are preferably driven via a motor 346 to move the profile cutting shuttle 340 back and forth across the material strip 12 in order to cut a desired profile. Profile cutting wheels 348, similar to profile cutting wheels 48, 48′ described above are preferably mounted for rotatory movement on the profile cutting shuttle 340. A motor 358 is used to drive the profile cutting wheel 348, and is also mounted on the shuttle 340. A belt 360 is used to connect the motor 358 to the profile cutting wheel 348. Preferably, a dust hood 361 is provided over the profile cutting wheel 348 in order to collect dust generated as a result of the profiling operation. Preferably, the dust hood 361 is connected to an appropriate vacuum source.

A pressure plate 362 which includes a slot or a plurality of slots 364 (shown in FIG. 17) to match the ribs of the cutting profiling 350 of the cutting wheel 348 is mounted to the moveable support 334. Preferably, the motor 358 is a five horse power motor and the profile cutting wheel 348 is approximately 24 inches long in order to provide a high throughput of profiled material through the profile cutting assembly 330. The direct up and down movement of the moveable support 334 via the actuators or lift cylinders 338 also provides for a faster operation as well as less vibration due to lateral movement of the moveable support 334. The profile 350 of the profile cutting wheel 348 can be varied, depending upon the particular application.

As in the first embodiment, at each position corresponding to a rib location on a contoured roofing panel, a rib profile is cut into the strip of material 12 by utilizing the lift cylinders 338 to lower the moveable support 334 such that the pressure plate 362 contacts the top surface of the strip of material 12 to hold it firmly in position. The motor 358 drives the profile cutting wheel 348 as the profile cutting shuttle 340 is moved in at least one direction by the linear actuators 344 which are driven by the motor 346, across the strip of material 12 to cut the rib profile into the strip. The lift cylinders 338 are then actuated to move the moveable support 334 upwardly such that the profile cutting wheel 348 and pressure plate 362 are no longer in contact with the strip of material 12. The material strip 12 is indexed forward and the process is repeated for the next rib location or set of rib locations.

The pressure plate 362 is held in position in a similar manner to the pressure plate 62 in accordance with the first embodiment via quick release clamps 366, as shown in FIG. 17.

Referring again to FIG. 14B, a negative or undercut profile cutting assembly 440 is shown. The undercut profile cutting assembly 440 is similar to profile cutting assembly 130 shown in FIG. 9. However, preferably two endless cutting bands 435, 435′ are provided. The endless cutting bands 435, 435′ may be a toothed blade or a grit-impregnated or coated strand of material which is moved via wheels 437, 439/437′, 439′ in order to cut a rib profile into the strip of material 12. The undercut profile cutting assembly 440 includes a moveable platform 444 which is mounted to the frame 332 by four jack screws 445. The jack screws 445 are connected together via a toothed belt or chain 446 which can be driven synchronously by a motor 447 in order to move the moveable support platform 444 up and down. Linear actuators 448 are located on the moveable support platform 444 in order to move the support frame 450 upon which the wheels 437, 439/437′, 439′ are mounted, back and forth in the direction of travel of the strip of material 12. Each endless cutting band 435,435′ is driven via a motor 452. In the preferred embodiment, each endless cutting band 435, 435′ is an abrasive grit coated strand. Preferably, a first set of wheels 437, 439 with the first cutting band 435 is mounted on an adjustable frame assembly 460 such that first band 435 can be adjusted closer to or further from the second endless cutting band 435′. The frame 460 is mounted on linear guides 462 and is positioned via jack screws 464. A crank handle 466 is utilized to turn a first jack screw 464 and is connected to the second jack screw 464 via a chain or toothed belt 468 and sprocket or pulley 469. In the event that only a single undercut profile is required, one of the endless blades 435, 435′ can be removed. However, in the event that two repeatable profiles are required, both endless blades 435, 435′ can be utilized in order to increased throughput.

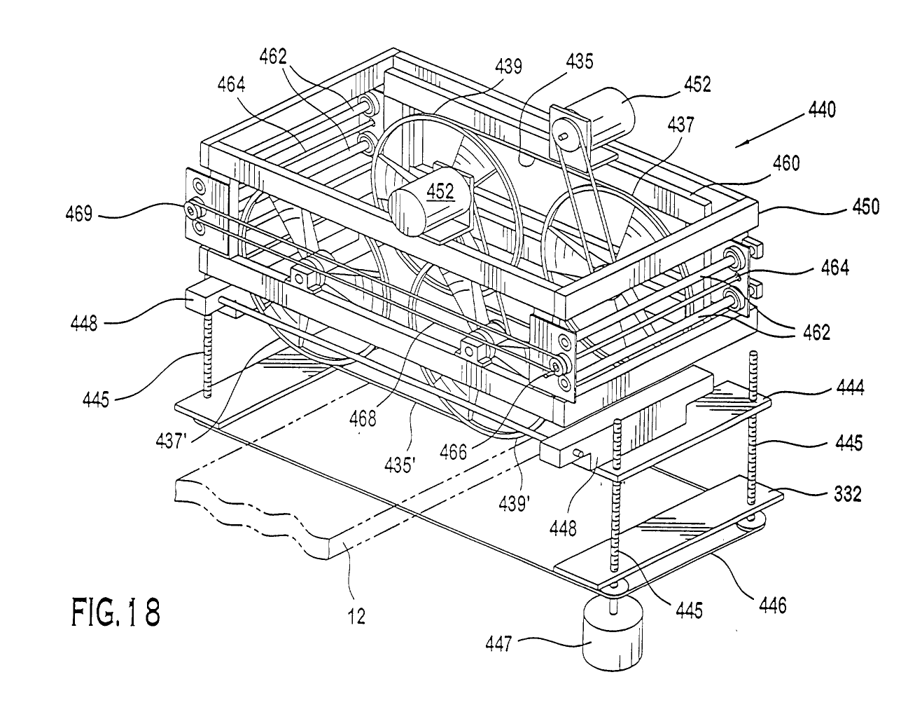

Still with reference to FIG. 18, in operation the strip of material 12 is stopped in a desired position along the conveyor path 20. Preferably, the strip of material 12 is held in position by rollers or a hold-down plate, not shown, outside of the area being cut. The jack screws 445 are driven via the servomotor 447 in order to place the endless bands 435, 435′ into contact with the surface of the material 12. The linear actuators 448 are then actuated in connection with controlled movement of the Acme screws 445 in order to move the frame 450 carrying the endless cutting bands 435, 435′ upwardly and downwardly and back and forth in order to cut the desired profile. This arrangement can be used to create undercut profiles, such as an L-shaped or J-shaped cut out in the strip of material 12, or other trapped profiles in which the opening in the upper surface of the strip 12 is smaller than the inner cut out area. Once the desired profile has been cut, the Acme screws 445 are utilized to lift the frame 450 with the endless cutting bands 435, 435′ from the material strip 12, and the material 12 is indexed forward where the process is repeated in order to cut the next profile or set of profiles.

By providing full X-Z motion of the frame 450 which carries the endless cutting bands 435, 435′, it is possible to cut any desired profile in a controlled manner. A programable controller such as the controller 70 as described is used to control the motor 447 and linear actuators 448 to create the desired movement of the endless cutting bands 435, 435′ in order to form the profiles.

Referring again to FIG. 14B, in order to remove trapped material from undercut profiles in the strip 12, a stripper station 470 is provided. The stripper station 470 includes a curved section of the path 20 in the form of a first roller 472 over which the strip of material 12 is wrapped at least partially around. A brush belt or rotatory brushes 474 are located above the strip of material 12 in the area where it is wrapped around the roller 472. The brushes 474 contact the upper surface of the material 12 and dislodge any trapped excess material in the undercut profiles. Preferably, a motor 476 is utilized to drive the brushes or brush belt 474. While it is preferred that the brushes travel in a direction transverse to the direction of travel of the material strip 12 in order to clear excess material from undercut profiles, it is also possible to use brushes 474 which run parallel to the direction of travel of the material strip 12 or at an offset angle. While the material strip 12 is shown as being drawn downwardly over the roller 472 in FIG. 14B, those skilled in the art will recognize that the material strip 12 could be bent upwardly over a set of rollers to provide the same effect of opening the material strip 12 around the undercut profiles.

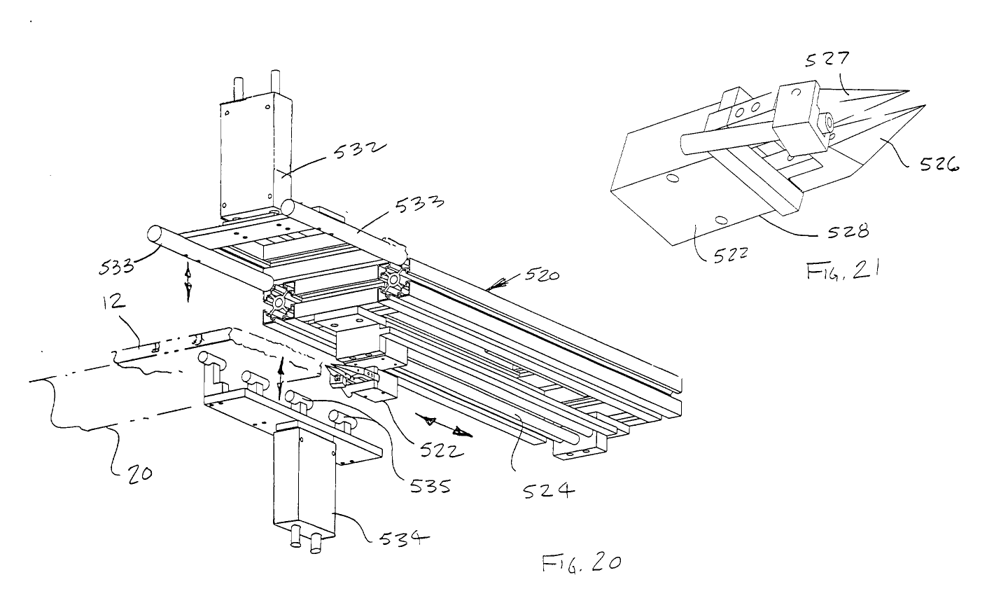

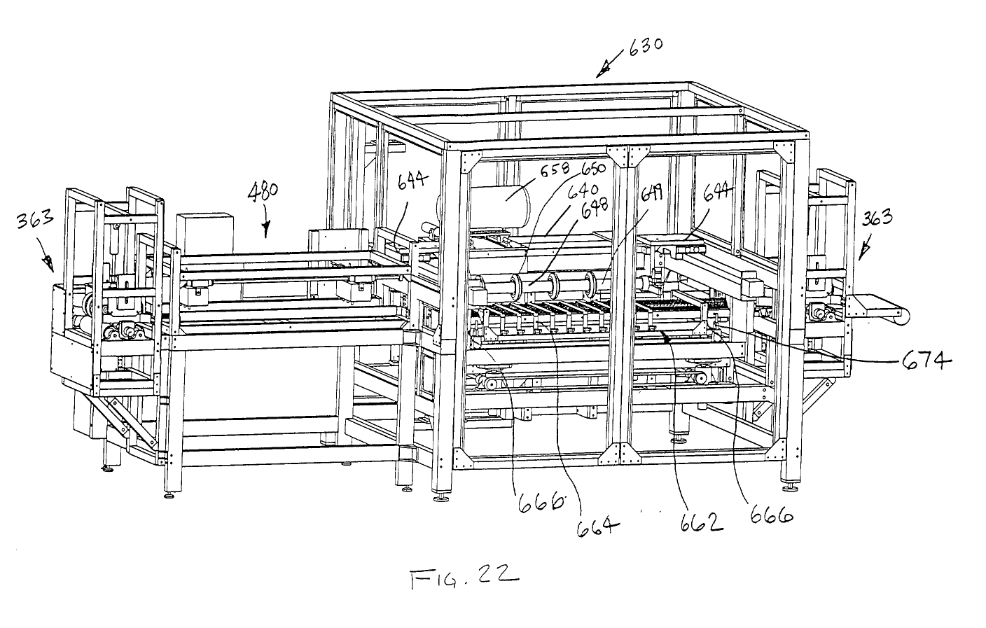

Alternatively, as shown in FIGS. 20 and 21, the stripper station 470 may be formed from a pincher assembly 520 that is located along the conveyor path 20. The pincher assembly 520 includes a pincher head 522 that is mounted on a linear actuator 524 for lateral movement toward and away from the conveyor path 20, in an aligned position with the undercut profiles. The pincher head 522 includes at least one moveable pincher 526 and an opposing pincher 527 which may be fixed or moveable. An actuator 528 on the pincher head 522 is actuated by the controller 70 to grip the excess material left in the under cut profile, and the linear actuator 524 is then used to move the pincher head 522 away from the conveyor path 20 to extract the excess waste material that has been cut away in the undercut profiling process. An air nozzle 530 may be located on the head 522 to ensure that the removed material is dropped when the pinchers 526, 527 are opened by providing an air jet pulse.

Preferably, upper and lower actuator assemblies 532, 534 are provided above and below the conveyor path 20, respectively. The upper actuator assembly 532 includes two bars 533 which are spaced on either side of an undercut profile location. The lower actuator 534 includes a central bar or bar segments 535 which are generally vertically aligned with the undercut profile location. Prior to activating the linear actuator 524 for moving the pincher head assembly 522 toward the material strip 12 on the conveyor path 12, the upper and lower actuator assemblies 532, 534 are actuated so that the bars 533 on the upper actuator assembly 532 and the central bar 535 on the lower actuator assembly 534 engage the strip of material 12 on the conveyor path 20, causing a localized deflection of the material 12 so that the upwardly facing undercut profile is opened up to assist in releasing the excess waste material.

Referring now to FIG. 14C, a glue station 480 is shown. The glue station 480 dispenses heated glue via manifold 482 at selected positions along the strip 12. The glue manifold 482 includes a plurality of nozzles 484, as shown in FIG. 19. Glue is pumped to the nozzles via a tube 486. Preferably, the position of the manifold 482 can be adjusted by sliding the manifold 482 back and forth along linear guides 488 in order to dispense glue onto the strip 12 in a desired position, preferably in to the profile cut into the material strip 12 by the profile cutting assembly 330. The glue is used to hold the strip 12 in position during installation. However, depending upon the profile configuration, the glue station 480 can be omitted, if desired.

Still with reference to FIG. 14C, a slitting saw 490 is located downstream of the glue applicator 480. The slitting saw 490 preferably includes one or more abrasive wheels or rotatory blades 492 which are spaced apart on an axle 494 in order to slit the strip of material 12 into a plurality of narrower strips 12′. The abrasive wheels or blades 492 on the axle 494 are driven via a motor 496. Preferably a dust hood 498 is located over the abrasive wheels or rotatory blades 492 in order to collect dust or debris generated during the slitting operation. As noted above in connection with the first embodiment other types of slitters may be used.

Preferably, the profile and slit strips of material 12′ are wound or rollers or a spool located in a take-up station, similar to the station 96 shown in FIG. 1. Alternatively, the strips 12′ may be folded for packaging or other automated means maybe utilized.

Those skilled in the art will recognize that the profile cutting station 330 may be used in conjunction with the undercut profiling station 440, or that either may be used separately in order to cut the desired profiles in a strip of material 12.

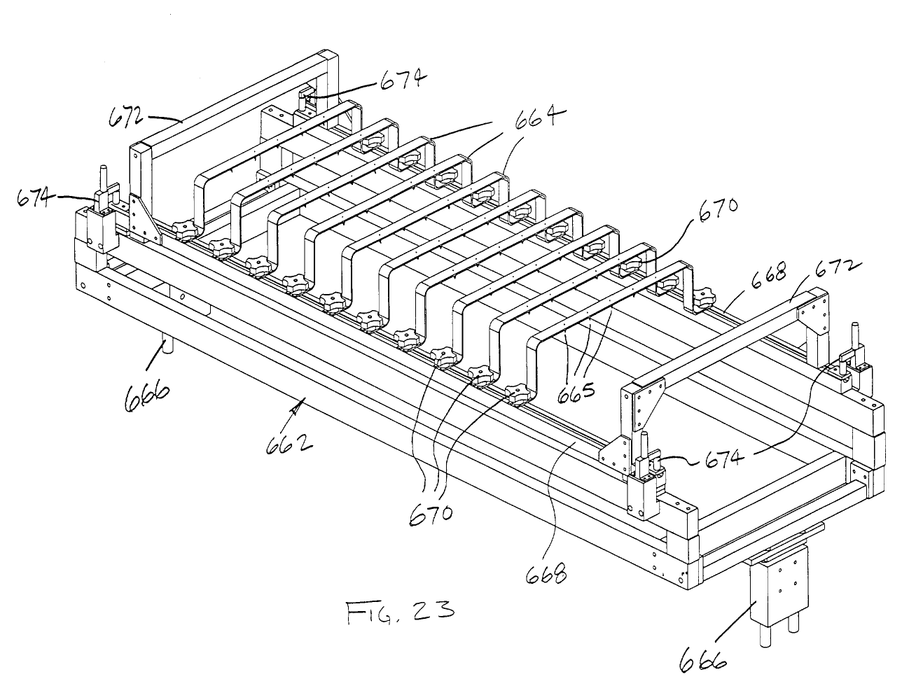

Referring now to FIGS. 22 and 23, a second alternate embodiment of the profile cutting assembly 630 is shown along with the glue station 480 and two drive stations 363. In the profile cutting assembly 630, the profile cutting shuttle 640 which carries the cutter assembly 648 and the drive motor 658 only moves back and forth across the conveyor path 20, moved by linear actuators 644. The linear actuators 644 are sized to allow the profile cutter assembly 648 to be moved completely out of the conveyor path 20 in the rest position.

An adjustable hold down assembly 662 is mounted across the conveyor path 20. The hold down assembly 662 is formed from a plurality of adjustable hold down straps 664 having downwardly extending studs 665 for engaging in the material 12 to firmly hold it in position, as shown in detail in FIG. 23. The hold down assembly 662 is mounted on at least two actuators 666 which are controlled by the controller 70 to move the hold down assembly 662 up so that the material 12 can be indexed forward along the conveyor path 20 to a determined position for cutting a given repeating profile, and can then be lowered so that the studs 665 on the hold down straps 664 engage the material 12 and firmly hold it in position during cutting. The position of the hold down straps 664 can be adjusted to any particular cutter spacing and configuration by sliding the straps 664 to the desired position along the rails 668 and locking them in position using the screw clamps 670. To assist in the set-up process, the assembled rails 668, fixed cross-pieces 672 and hold down straps 664 can be removed from the hold down assembly 662 using four corner clamps 674.

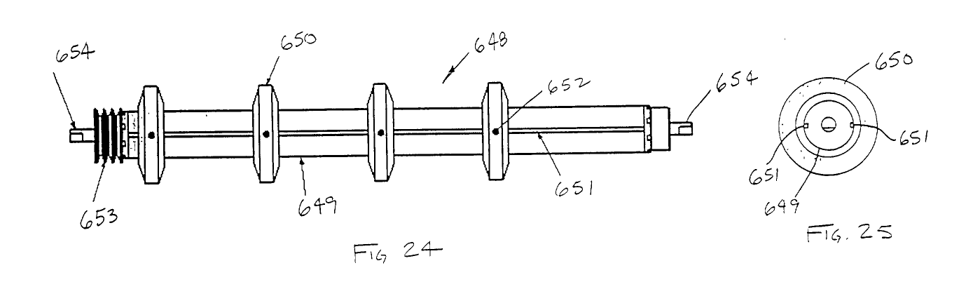

Referring now to FIGS. 22, 24 and 25, the advantage of this embodiment of the profile cutting assembly 630 is that the cutter assembly 648 is formed from a universal cutting shaft 649 and a plurality of removable and repositionable cutting rings 650. The shaft 649 preferably includes an outer body that is supported by bearings on a fixed central shaft that can be clamped in position on the profile cutting shuttle 640. Two keyways 651 are provided on the outer surface. The cutting rings 650 are preferably formed from tool steel to the desired profile shape and coated with a tungsten carbide grit. The rings 650 can be slid onto the universal shaft 649 and adjusted to a desired position to match a roof panel profile or other profile that is being matched. The rings 650 are then locked in position using set screws 652 which engage in the shaft keyways 651. A pulley 653 is provided at one end of the shaft 649 and is driven by the motor 658. The cutter assembly 648 is removably mounted to the profile cutting shuttle 640, and belts are then installed between the pulley 653 and a pulley on the motor 658. This arrangement allows fewer tools to be utilized to cut a multitude of profiles. Additionally, the cutter assembly 648 can be set up remotely from the profile cutting assembly 630 and then mounted in position. The adjustable hold down assembly 662 can be set up to match the cutter assembly 648. Preferably, the cutter assembly is at least 36 inches long, and may be 42 or 48 inches long, or any other desired length, so that a greater number of profiles can be cut in a single pass. Additionally, multiple rings 650 may be positioned against one another to form bigger profiles using smaller tools that are cheaper to produce.

The profile cutting assembly 630 provides a speed advantage not only due to the increase in the length of the cutter assembly 648, but also due to the separation of the movement of the hold down assembly 662 from the profile cutting shuttle 640. This also can reduce machine vibration which allows for more precise positioning, indexing and cutting of profiles in the material 12. The cutter assembly 648 provides additional flexibility in cutting different profiles without incurring substantial retooling charges for each different profile. Additionally, compound profiles formed from two or more closely spaced or abutting cutting rings 650 can be formed.

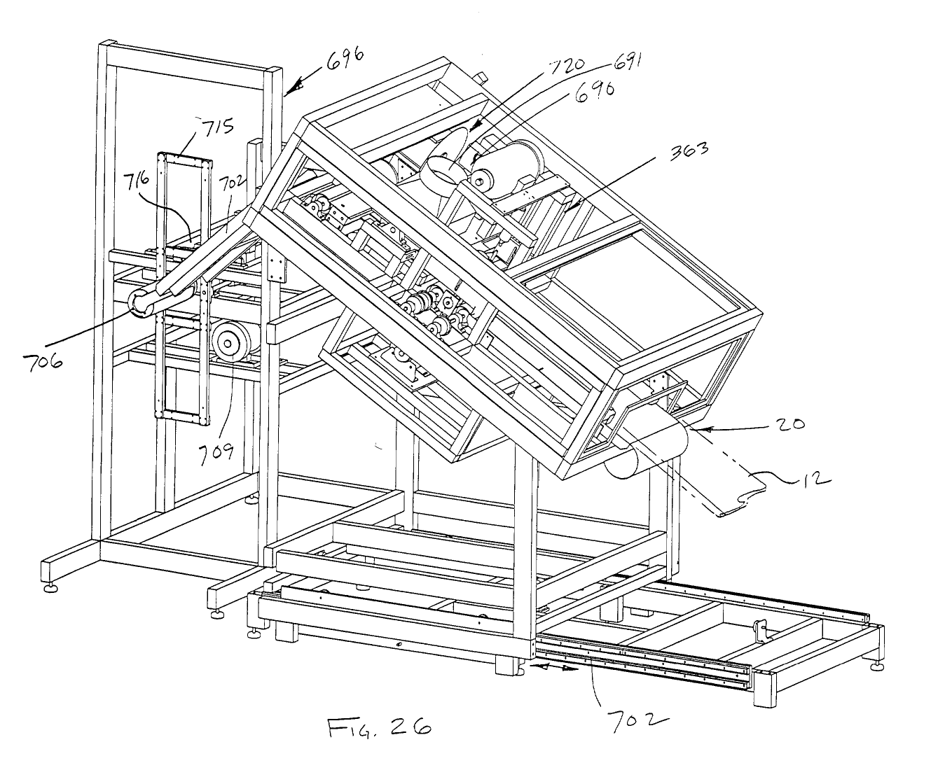

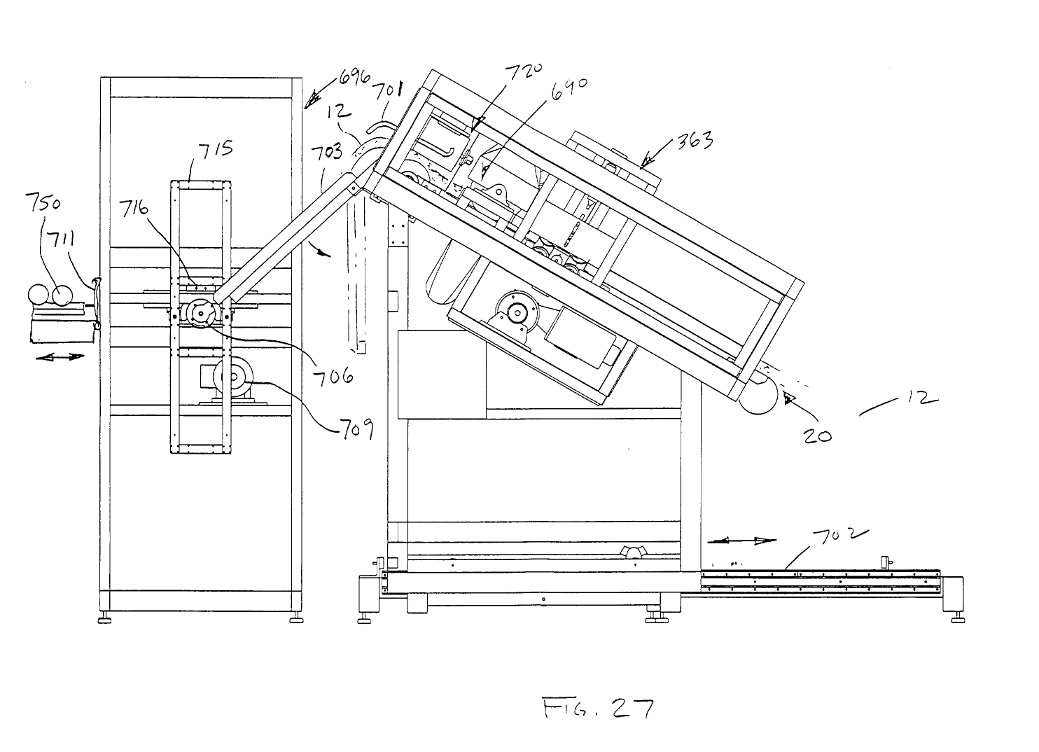

Referring now to FIGS. 26 and 27, an alternate embodiment of the slitter 690, a cut-off saw 722 and a drive pod 363 which have been combined in one station 700 located at the end of the conveyor path 20 is shown. The station 700 is tilted generally upwardly from horizontal so that the material 12 that travels along the conveyor path 20 is raised to a higher elevation to assist in winding the finished product into rolls on the winding station 696. The drive pod 363 is as described above. The slitter 690 is also the same as the slitter 490 as described above, except it is mounted at an angle. The cut-off saw 722 is the same as the cut-off saw 22 except it is mounted at an angle. If the cut-off saw 722 is utilized, the upstream cut-off saw location described in the first embodiment of the invention is omitted. Preferably, at least one dust collection hood 691 is provided in the area of the slitter 690 and cut-Off saw 722. The station 700 is preferably mounted for movement on rails 702 so that it can be moved toward or away from the winding station 696, depending on the length of the material 12 being wound into a single bundle.

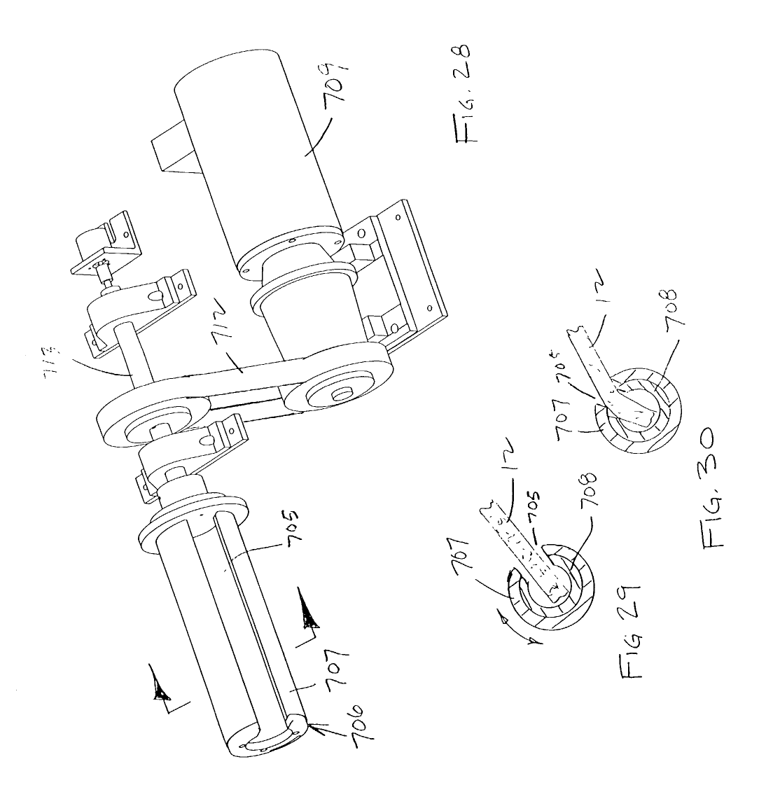

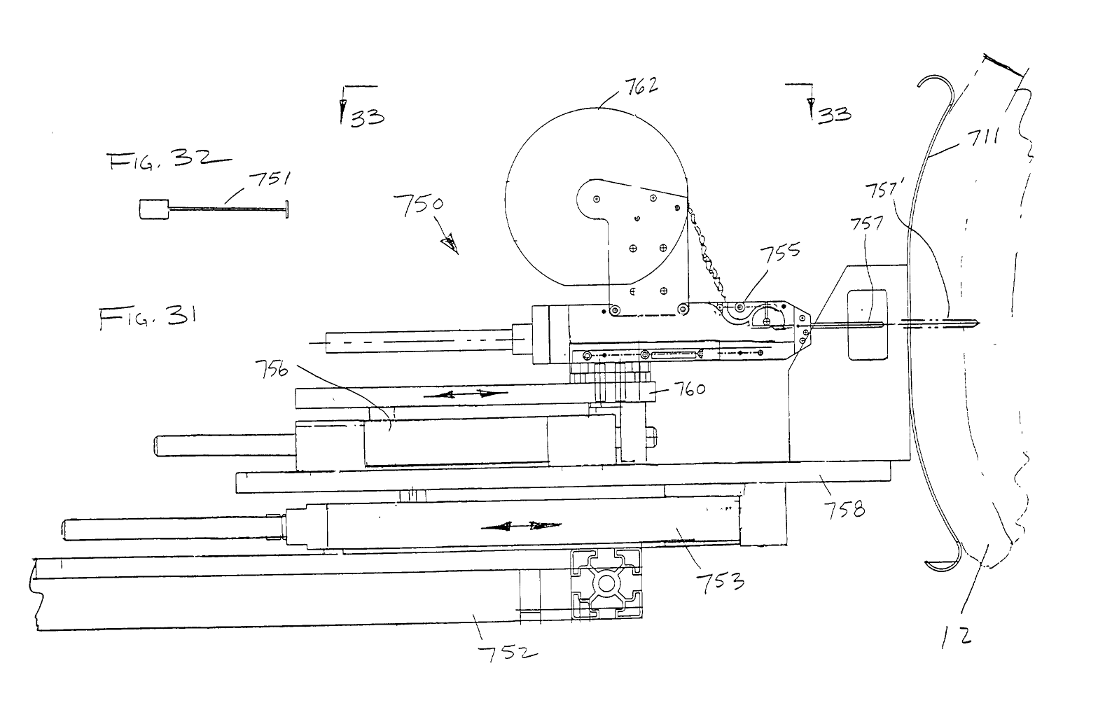

The material 12 is fed along the conveyor path 20 through the station 700, where it is slit. As shown in FIG. 27, it then exits the station 700 at the upper end, where it is preferably guided by a smooth guide 701 to ensure that the ends of the material 12 clear the frame of the station 700 and are directed into a pivotable chute 703, shown in the up position in FIG. 27, which directs the ends of the material 12 to the winding spool 706 located on the winding station 696. The ends of the material 12 enter a slot 705 in the spool 706, and are then clamped in position, as shown in FIGS. 29 and 30, by an outer clamp sleeve 707 being rotated relative to the inner spool 708. The chute 703 is then pivoted downwardly to a stowed position, as shown in broken lines. The inner spool 708 is then driven by the winder motor 709 in order to wind the slit material 12 into bundles. When a predetermined length of the material 12 has been slit, the cut-off saw 722 is actuated to cut off the material 12. The inner spool 708 continues the winding process until all of the material 12 has been wound. Holder plate(s) 711 holds the wound material in the wound position. The size and shape of the holder plate(s) 711 can be varied. The winder motor 709 is preferably controlled by the controller 70 in order to wind the required number of turns to form a bundle of material 12 for a given length of material.

The drive arrangement for the inner spool 708 is shown in detail in FIG. 28, where a belt 712 is connected between the motor 709, which is controlled by the controller 70, and a shaft 713 connected to the inner spool 708. The outer clamp sleeve 707 is preferably free to turn on the inner spool 708, and the combined contact with the material 12 and the rotation of the inner spool 708 causes it to clamp the ends of the material 12 in position, as shown in FIG. 30.

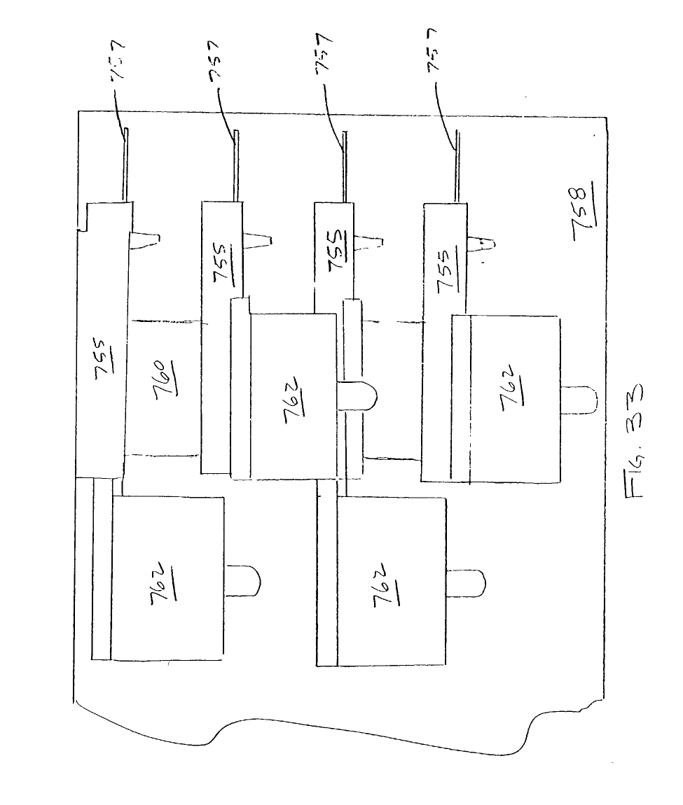

As shown in FIG. 27, a stapler assembly 750 is preferably located adjacent to the winding station 696. The stapler assembly 750, which is shown in more detail in FIGS. 31 and 33 preferably inserts a barbed holding element 751, shown in FIG. 32, which is preferably made of plastic and is of the type typically used to attach removable tags to clothing, through the end of the material 12 and into the wound layers underneath to hold the wound material strips in roll form. The stapler assembly 750 is preferably mounted to a frame 752 via an actuator 753 which moves the stapler assembly 750 to the proper position, depending on the size of the roll of material 12 being wound. Preferably, four staplers 755 are mounted on a support 760 that is connected via a second actuator 756 to a support 758 attached to the first actuator 753. Feed spools 762 are provided for linked barbed holding element “staples” 751which are fed to the staplers 755 so that upon actuation, the stapler needle 757 of each stapler 755 is inserted through the first layer of material 12 and into the second layer (as shown in broken lines as 757′) and a “staple” 751 is inserted. The staplers 755 are preferably of the known types used for inserting hold tags for clothing, which is an Avery Dennison Model 11005 with an extra long heavy duty needle no. SPU12N. While four staplers 755 are provided in the preferred embodiment because the material 12 is slit into four strips, more of less staplers 755 could be utilized depending on the number of strips of material being wound. Other types of staplers could be utilized to insert the barbed holding elements 751, if desired.

Referring again to FIGS. 26 and 27, once the strips of material 12 have been wound and stapled, a pusher 715 mounted on a linear actuator 716 can be actuated by a user, preferably using a foot switch (not shown), to push the wound and stapled bundles of slit material 12 off of the spool assembly 706. The process can then be repeated by moving the chute 703 back to the up position and feeding additional slit material 12 down the chute 703 and into the spool assembly 706.

Preferably, the profile cutting assembly 630 is used in conjunction with the unwid station 316 and the calendaring station 325 described above. The drive pods 363, the profile cutting assembly 630, the glue station 480, the cut-off saw 720 and the slitter 690 are all controlled by the controller 70 so that the material 12 is moved along the conveyor path 20 in indexed intervals so that a repeating profile can be cut into the material 12 by the profile cutting assembly 630 as it is indexed forward, glue spots can be placed on the material 12 at the glue station 480, preferably in the profile cut-outs, a preset amount of the material 12 is slit by the slitter 690 and then introduced into the spool assembly 706 of the winder 696, and wound so that a desired length of the material is past the cut-off saw 722, which is then activated to cut the material 12 being wound to length. The winding continues until the free ends are either manually or automatically indexed to near the position of the stapler assembly 750, which is then actuated to staple the ends of the wound material strips in place. An operator can then actuate the pusher 715 so that the wound material is unloaded for packaging and shipping.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A cutting system for cutting profiles in a strip of material comprising:
a conveyor path to support a strip of material;
a strip positioning system adapted to move the strip of material along the conveyor path;
a profile cutting tool located along the conveyor path and mounted for movement across the conveyor path to cut a desired profile across the strip;
a strip hold down located in proximity to the profile cutting tool and on a same side of the conveyor path mounted for movement toward and away from the conveyor path to hold the strip of material in position during cutting; and
a controller connected to the profile cutting tool which activates the profile cutting tool to cut the desired profile into the strip of material at desired intervals as the strip of material is moved along the conveyor path.

2. The cutting system of claim 1, wherein the profile cutting tool comprises a motor driven cutter mounted on a shuttle for movement across the conveyor path.

3. The cutting system of claim 2, wherein the cutter comprises a shaped mandrel having an abrasive contact surface.

4. The cutting system of claim 2, wherein the cutter is comprised of a universal shaft and a plurality of cutting rings that are positionable and lockable on the shaft.

5. The cutting system of claim 2, whereby the strip hold down comprises at least one of a pressure plate and hold down strips which is moveable from a first position above the conveyor path, to a second position in which the pressure plate is adapted to contact the strip of material.

6. The cutting system of claim 1, wherein the profile cutting tool comprises an endless cutting band.

7. The cutting system of claim 6, wherein the profile cutting tool is also mounted for back and forth movement in a direction of the conveyor path.

8. The cutting system of claim 1, wherein the profile cutting tool comprises a rotary cutting shaft.

9. The cutting system of claim 1, further comprising a glue station located down stream from the profile cutting assembly adapted to apply glue to at least a portion of a face of the material strip.

10. The cutting system of claim 1, further comprising a slitter to cut the strip of material into a plurality of narrower strips.

11. The cutting system of claim 10, wherein the slitter comprises at least one abrasive wheel.

12. The cutting system of claim 1, further comprising a second profile cutting tool located along the conveyor path, the second profile cutting tool comprising an endless cutting band supported by two wheels mounted to a moveable frame, the moveable frame being mounted for controlled movement toward and away from the conveyor via a first actuator and for controlled movement back and forth in a direction of the conveyor path via a second actuator such that an undercut profile can be cut.

13. The cutting system of claim 1, further comprising a calendaring system located upstream of the profile cutting tool.

14. The cutting system of claim 13, wherein the calendaring system includes a heated tunnel located around the conveyor path, at least two opposing calendaring wheels downstream from the heated tunnel, and a blower oriented to blow air toward the calendaring wheels.

15. The cutting system of claim 1, further comprising a cutting assembly located adjacent to the conveyor path adapted to cut the strip of material to a desired length, the cutting assembly connected to the controller.

16. The cutting system of claim 15, wherein the cutting assembly comprises a rotary blade or an abrasive wheel.

17. The cutting system of claim 1, further comprising a take-up assembly adjacent to the conveyor system, the take-up assembly including a motor driven spool adapted to receive the strip of material, the motor driver spool being connected to the controller.

18. The cutting system of claim 17, wherein an outer clamping sleeve is located on the spool.

19. The cutting system of claim 17, further comprising a stapler assembly having a plurality of staplers located adjacent to the take-up assembly which are adapted to insert a barbed holding element into the material after it is wound.

20. The cutting system of claim 17, further comprising a pusher located adjacent to the spool, the pusher is connected to an actuator for movement of the pusher in an axial direction of the spool to discharge wound material from the spool.

21. The cutting system of claim 1, further comprising at least one calendar roll, the calendar roll being located adjacent to the conveyor path upstream from the profile cutting tool, the calendar roll being adapted to contact and stabilize the strip of material.

22. The cutting system of claim 1, further comprising a baffle cutting and filling station located along the conveyor path having at least one movable rotary cutter oriented to cut a longitudinal groove in the strip of material to form a baffle portion;
a motor connected to the rotary cutter; and
an injection filler adapted to apply filling materials to the baffle portion of the strip.

23. A method for profiling strips of air-permeable, resilient material comprising:
providing a strip of air-permeable, resilient material;
holding the strip of air-permeable, resilient material in position along a conveyor path on a first side;
cutting a profile in the strip of air-permeable, resilient material with a profile cutting tool on the first side;
moving the strip of air-permeable resilient material forward along the conveyor path; and
repeating the steps of holding and cutting in order to form a strip having a repeating profile.
